(19) United States
(12) Patent Application Publication
(10) Pub. No.: US 2025/0077542 A1
(43) Pub. Date: Mar. 6, 2025

(54) METADATA MANAGEMENT SYSTEM FOR INTER-COMPANY DATA SHARING

(71) Applicant: WITHFUTURE CO., LTD., Gyeonggi-do (KR)

(72) Inventors: Hae Jeong LEE,, Seoul (KR); Kwang Hoon KO, Incheon (KR); Eui Hyun RO, Gyeonggi-do (KR)

(73) Assignee: WITHFUTURE CO., LTD., Gyeonggi-do (KR)

(21) Appl. No.: 18/519,140

(22) Filed: Nov. 27, 2023

(30) Foreign Application Priority Data
Sep. 4, 2023 (KR) 10-2023-0116734

(51) Int. Cl. G06F 16/25; G06F 16/215; G06F 16/23; G06F 16/28

(52) U.S. Cl. CPC G06F 16/258; G06F 16/215; G06F 16/2365; G06F 16/285

(57) ABSTRACT

The present invention relates to a metadata management system for inter-company data sharing, which includes: a provider terminal for inputting and registering corporate data and processing inter-company shared data registration; an integrated platform server including a data classification unit, a standardization processing unit, and a dataset management unit; and a consumer terminal for receiving the shared data through the integrated platform server to use the sharing data as corporate data. When new corporate data required by a consumer side is generated, the consumer terminal requests it to the provider terminal through the integrated platform server, and the requested new corporate data is registered as shared data upon completion of standardization registration and dataset registration in the provider terminal, and then provided to the consumer terminal. By standardizing and managing data on corporate activities generated by various companies by industry and business, and through inter/intra-company uniform data sharing, efficiency of data sharing and data using throughout the corporate activities, such as productivity improvement, facility automation, and equipment control efficiency, can be increased.

### FIELD OF THE INVENTION

The present invention relates to a metadata management system for inter-company data sharing, and more particularly, to a metadata management system for inter-company data sharing which is capable of defining standardized meta information and managing corporate data through industry-specific standardization and company-specific standardization based thereon.

### BACKGROUND OF THE INVENTION

As interest in and demand for big data increases, the need for data standardization is increasing. The data standardization can bring about the expected effects of clear communication and understanding of data, and can reduce costs and resources in the data conversion or refining process caused by improving data quality, which is most important in the data analysis and machine learning areas.

The data standardization means establishing principles for names, definitions, rules, and formats of data information elements scattered in a system and applying them throughout a company. Standardization also has the effect of reconciling conflicting perspectives on each data.

Data and metadata are stored in a file system, and the metadata is used to find data. For example, the location of a hard disk or computer where the data is stored can be treated as the metadata, and if the metadata is known, it is possible to find the data that the metadata points to.

The data standardization is one of the essential tasks to ensure data quality. Due to simultaneous system development, lack of data management mindset, and absence of data management personnel and tools, data duplication and inconsistency may occur, and data integration is also difficult. This phenomenon is more likely to cause problems in situations where data increases exponentially.

With the acceleration of the information age, the data industry is growing exponentially, and data collection, management, analysis, and operation are essential in all corporate business activities.

In particular, in industrial sites, the importance of utilizing data between trading companies is continuously required to not only improve productivity through data sharing between the companies for equipment data, operation data, work data, etc., but also to solve problems and optimize system management.

### PRIOR ART DOCUMENT

### Patent Document

Korean Patent Registration No. 10-2175183

Korean Patent Registration No. 10-0899616

Korean Patent Registration No. 10-1689257

Korean Patent Registration No. 10-1764654

Korean Patent Registration No. 10-1932734

Korean Patent Publication No. 10-2023-0053880

Korean Patent Registration No. 10-2540944

Korean Patent Registration No. 10-2498062

Korean Patent Registration No. 10-2046640

### SUMMARY OF THE INVENTION

In view of the above, the present invention provides a metadata management system for inter-company data sharing which is capable of increase the efficiency of data sharing and data utilization throughout a company, such as productivity improvement, facility automation, and equipment control efficiency, through uniform data sharing between companies or within the company by standardizing and managing data on corporate activities generated by various companies by industry and business.

In accordance with one embodiment of the present invention, a metadata management system for inter-company data sharing, comprises: a provider terminal for, when corporate data including management data, equipment data, operation data, work data, computer data, and accounting data generated from corporate activities are created, inputting the corporate data to check whether the corporate data is standard data and process standard data registration if not registered, processing shared data registration for sharing the corporate data between companies through dataset registration for the standard data registered; an integrated platform server including: a data classification unit configured to classify the corporate data into transaction data, master data, and metadata when the standard data registration is processed by the provider terminal; a standardization processing unit configured to standardize the corporate data according to classification by company and business; and a dataset management unit configured to classify and store the corporate data processed in the standardization processing unit as datasets grouped into arbitrary groups, the integrated platform server registering corporate data generated by the provider terminal as shared data through standardization registration and dataset registration and then providing the shared data to a consumer side; and a consumer terminal for receiving the shared data standardized and processed into a dataset through the integrated platform server to use the shared data as corporate data required for corporate activities, wherein when new corporate data required by the consumer side is generated, the consumer terminal requests the new corporate data to the provider terminal through the integrated platform server, and the requested new corporate data is registered as shared data upon completion of standardization registration and dataset registration in the provider terminal, and then provided to the consumer terminal.

Further, the data classification unit includes: a classification definition unit that defines corporate data received from the provider terminal as transaction data, master data, and metadata; and a domain management unit that manages corporate data by domain for each data defined in the classification definition unit.

In addition, the dataset management unit includes: a dataset registration unit that registers corporate data that has been standardized in the standardization processing unit as a dataset; and a data sharing unit that shares data registered as the dataset when requested by the consumer terminal.

The metadata management system for inter-company data sharing, according to the present invention, has the effect of improving the efficiency of inter/intra-company data management by standardized processing of different corporate data by company and business and managing them as metadata, thereby improving operational efficiency through inter/intra-company data management, such as quality improvement and productivity improvement.

### BRIEF DESCRIPTION OF THE DRAWINGS

FIG. 1 shows an overall configuration diagram of a metadata management system for inter-company data sharing according to the present invention.

FIG. 2 shows a detailed configuration diagram of an integrated platform server in the metadata management system for inter-company data sharing according to the present invention.

FIG. 3 shows a detailed configuration diagram of a data classification unit in the metadata management system for inter-company data sharing according to the present invention.

FIG. 4 shows a detailed configuration diagram of a dataset management unit in the metadata management system for inter-company data sharing according to the present invention.

FIG. 5 shows a detailed configuration diagram of a consumer terminal and a provider terminal in the metadata management system for inter-company data sharing according to the present invention.

### DETAILED DESCRIPTION OF THE INVENTION

Hereinafter, a metadata management system for inter-company data sharing according to the present invention will be described in detail with reference to the accompanying drawings.

In the present specification, ‘unit’ includes a unit realized by hardware, a unit realized by software, and a unit realized using both. Further, one unit may be realized using two or more pieces of hardware, and two or more units may be realized using one piece of hardware. Meanwhile, ‘. . . unit’ is not limited to software or hardware, and ‘. . . unit’ may be configured to reside in an addressable storage medium or may be configured to reproduce one or more processors. Therefore, as an example, ‘. . . unit’ includes components such as software components, object-oriented software components, class components, and task components, processes, functions, attributes, procedures, subroutines, segments of program code, drivers, firmware, microcodes, circuits, data, databases, data structures, tables, arrays, and variables. The functions provided within the components and ‘. . . units’ may be combined into a smaller number of components and ‘. . . units’ or may be further divided into additional components and ‘. . . units’. In addition, the components and ‘. . . units’ may be implemented to regenerate one or more CPUs within a device or secure multimedia card.

The “terminal” mentioned below may be implemented as a computer or a portable terminal that can access to a server or another terminal through a network. In this case, the computer may include, for example, a laptop, a desktop, a laptop, a VR HMD (e.g., HTC VIVE, Oculus Rift, GearVR, DayDream, PSVR, etc.), etc. equipped with a web browser.

In this case, VR HMD includes those for PC (e.g., HTC VIVE, Oculus Rift, FOVE, Deepon, etc.), those for mobile (e.g., GearVR, DayDream, Storm Magic, Google Cardboard, etc.), and Stand Alone models (e.g., Deepon, PICO, etc.) implemented independently of that for console (PSVR). The portable terminal is, for example, a wireless communication device that ensure portability and mobility, and may include not only a smartphone, a tablet PC, and a wearable device, but also various devices equipped with a communication module such as Bluetooth (BLE, Bluetooth Low Energy), NFC, RFID, ultrasonic, infrared, WiFi, LiFi, etc.

In addition, the “network” refers to a connection structure that allows information exchange between nodes such as terminals and servers, and includes a local area network (LAN), a wide area network (WAN), and the Internet (WWW: World Wide Web), wired/wireless data communication network, telephone network, wired/wireless television communication network, etc. Examples of wireless data communication networks include, but are not limited to, 3G, 4G, 5G, 3GPP (3rd Generation Partnership Project), LTE (Long Term Evolution), WIMAX (World Interoperability for Microwave Access), Wi-Fi, Bluetooth communication, infrared communication, and ultrasound, visible light communication (VLC), LiFi, etc.

A metadata management system for inter-company data sharing, according to the present invention, includes: a provider terminal for, when corporate data including management data, equipment data, operation data, work data, computer data, and accounting data generated from corporate activities are created, inputting the corporate data to check whether it is standard data and process standard data registration if not registered, processing shared data registration for sharing the corporate data between companies through dataset registration for the standard data registered: an integrated platform server including a data classification unit configured to classify the corporate data into transaction data, master data, and metadata when the standard data registration is processed by the provider terminal, a standardization processing unit configured to standardize the corporate data according to classification by company and business, and a dataset management unit configured to classify and store the corporate data processed in the standardization processing unit into datasets grouped into arbitrary groups, the integrated platform server registering corporate data generated by the provider terminal as shared data through standardization registration and dataset registration and then providing the shared data to a consumer side; and a consumer terminal for receiving the shared data standardized and processed into a dataset through the integrated platform server to use the shared data as corporate data required for corporate activities, wherein when new company data required by the consumer side is generated, the consumer terminal requests it to the provider terminal through the integrated platform server, and the requested new company data is registered as shared data upon completion of standardization registration and dataset registration in the provider terminal, and then provided to the consumer terminal.

The metadata management system for inter-company data sharing, according to the present invention, provides a corporate data management system that can achieve smooth data sharing and all-round quality improvement of a company using shared data through data classification, data standardization, and dataset processing in order to efficiently share various corporate data generated from corporate activities.

In this case, according to the present invention, the shared data can be mutually shared through systematic data processing in the process of sharing corporate data, and the efficiency and quality of management activities between companies or within a company can be improved by utilizing the shared data.

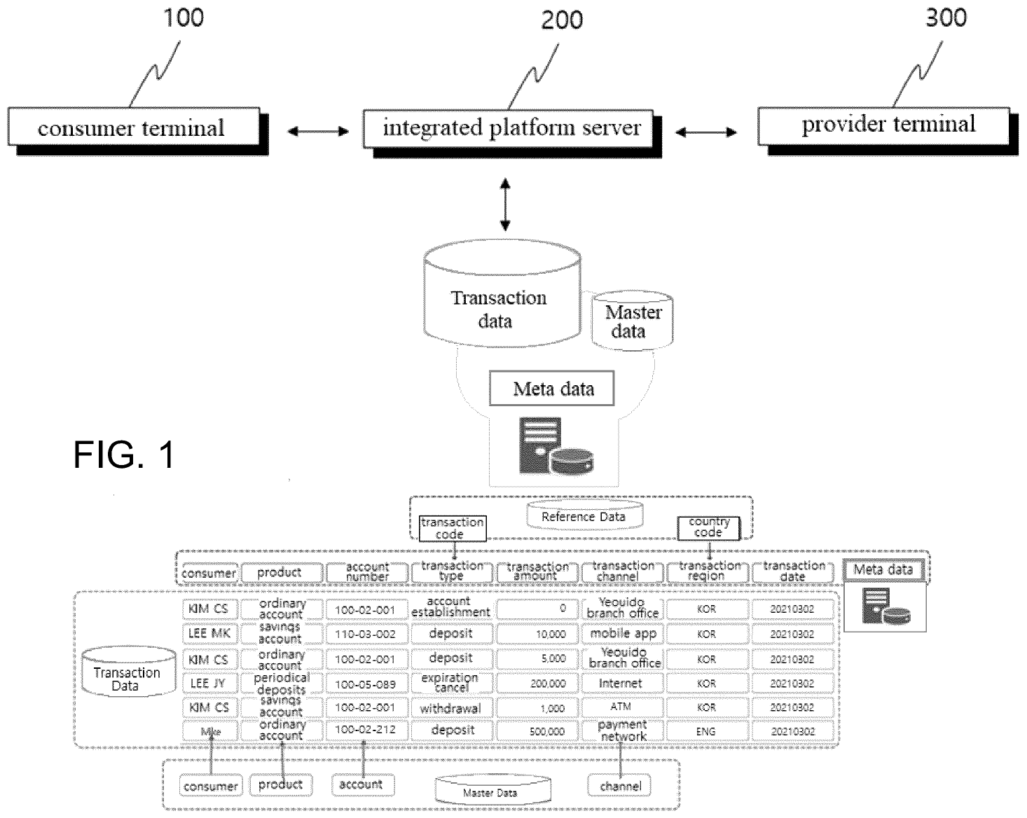

FIG. 1 shows an overall configuration diagram of the metadata management system for inter-company data sharing according to the present invention.

The present invention broadly includes a consumer terminal 100 that receives shared data provided from a provider providing corporate data and utilizes and manages it on a demander (or consumer) side, a provider terminal 300 that generates corporate data corresponding to the shared data and provides it to the consumer terminal 100, and an integrated platform server 200 that classifies, standardizes, and processes corporate data corresponding to the shared data as datasets so that it may function as shared data.

First, the provider terminal 300, which provides corporate data corresponding to shared data, generates various types of corporate data generated in corporate activities. In this case, corporate data refers to all data generated in corporate activities, and may include, for example, management data, equipment data, operation data, work data, computer data, accounting data, and the like. These corporate data have data types according to each company and business.

More specifically, equipment data may correspond to control values, output values, measured values, analysis values, and the like of equipment generated in factory equipment or an industrial plant, and computer data may correspond to all data included in computerized management such as transaction details, transaction dates, payment information, sales details, accessors, users, number of members, shipment information, receipt information, and the like that occur in platform companies, financial companies, e-commerce companies, distribution companies, real estate, and the like.

The corporate data is consistently generated in the course of the provider's corporate activities, and in order to provide the corporate data generated to the consumer side, the present invention creates a single shared data through a classification process, standardization process, and dataset process and provides it to the consumer.

Accordingly, when various types of corporate data are generated, the provider terminal 300 inputs them and first checks whether they are standard data or not through the integrated platform server 200. After the provider terminal 300 checks whether the corporate data has been registered as standard data, a next process is performed if it is registered, but if the data is not registered as standard data, the provider terminal 300 requests standard data registration first and proceeds with standard data registration.

After completing standard data registration, the dataset process of the relevant corporate data is performed. The dataset process is the process of grouping or aggregating similar data within source data.

Accordingly, the integrated platform server 200 registers the corporate data generated in the provider terminal as shared data through standardization registration and dataset registration, and then provides the shared data to the consumer (data user) requesting the shared data.

The consumer terminal 100 is a terminal used by a demand company that receives and utilizes shared data prepared by the integrated platform server 200. When shared data is needed, the consumer terminal 100 may request shared data to the integrated platform server 200 through an arbitrary procedure and then receive the shared data.

By utilizing the shared data provided, the demand company can use it for corporate activities such as work data matching, process data matching, and business cooperation, and can excellently utilize it in overall management such as productivity improvement, workability improvement, and efficiency improvement.

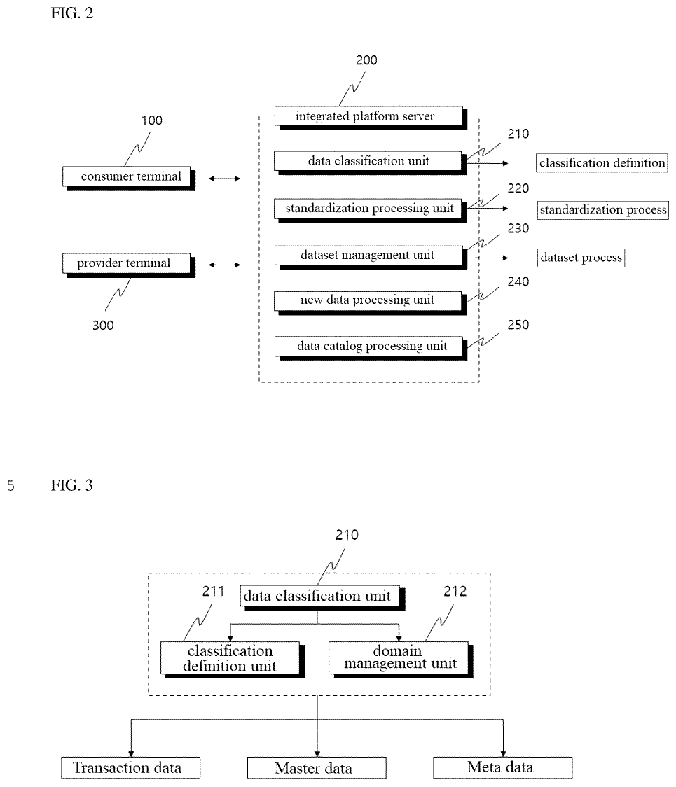

FIG. 2 shows a detailed configuration diagram of the integrated platform server in the metadata management system for inter-company data sharing according to the present invention.

As described above, the integrated platform server 200 according to the present invention functions as a platform which standardizes and processes corporate data corresponding to shared data between a provider and a consumer, that is, between companies, and processes and integrates corporate data so that the data can be easily confirmed or applied by the consumer.

The integrated platform server 200 includes a data classification unit 210 that classifies corporate data, a standardization processing unit 220 that standardizes the classified data, a dataset management unit 230 that processes the standardized corporate data as a dataset, a new data processing unit 240 that processes new data when it is input, and a data catalog processing unit 250 that catalogs metadata generated to provide shared data to the consumer.

When standard data registration is requested for corporate data generated in the provider terminal 300, the data classification unit 210 first classifies the corporate data into transaction data, master data, and meta data.

Specifically, the transaction data may correspond to information accumulated as a result of the operation of a business system that supports the company's business activities, and the master data may correspond to data attributes about the subject or object (customers, providers, employees, products, materials, parts, equipment, purchases, cost information) of the company's business activities. The metadata is information that constitutes data and may correspond to objects or items that need to be identified or controlled for integrated management of data.

In other words, the data classification unit 210 is configured to classify corporate data by arbitrary attributes, and the classification attributes may configure various classification systems depending on the company's business or characteristics.

The standardization processing unit 220 standardizes the corporate data classified by the data classification unit 210 as standard data. The standardization processing unit 220 standardizes corporate data according to classification by company and business. Through the data standardization, business standards (words, terms, and domains) and corporate standards (words, terms, and domains) are created and managed for each industry.

In this case, the standard data is a processing task for standardization management and refers to the task of standardizing the relevant corporate data, such as term standardization, word standardization, and domain standardization based on a standard dictionary. If standardization of corporate data is not achieved, the corporate data cannot function as shared data when provided to the consumer, so standardization registration is first processed on the corporate data.

The dataset management unit 230 performs dataset processing to group similar data on the standardized corporate data. A dataset is a bundle or set of similar data within corporate data that is the source data, and the grouping of similar data is called a dataset process.

The dataset management unit 230 stores grouped similar data in a separate storage and establishes a data management and standardization system through grouping.

Meanwhile, the integrated platform server 200 includes a new data processing unit 240 that receives newly input corporate data. New data refers to unstandardized initial corporate data. When new corporate data is input from the provider terminal or consumer terminal, the integrated platform server 200 receives a standardization request and allows the standardization processing unit 220 to perform the standardization work.

The data catalog processing unit 250 performs the function of cataloging and processing each metadata generated in the process of providing shared data generated through the data classification process, standardization process, and dataset process to the consumer.

When a data sharing request occurs through the data catalog processing unit 250, all datasets are checked to quickly retrieve the data and support is provided for sharing the data.

In this case, the data catalog processing unit 250 has a data processing function based on a deep learning model and performs a keyword-related search through a search engine for standard words, standard domains, standard terms, and datasets corresponding to various data components. Here, meta information context can be created through a deep learning analysis model through a deep learning analysis engine and data can be visualized through it. Specifically, words and terms are extracted by analyzing various documents (data) through the deep learning analysis model, and an analysis model of similar words and related words between the extracted words and terms is created.

Next, meta information context is created and through the analysis model, context between standard words, standard use domains, standard terms, and datasets is created to search data.

Accordingly, the data catalog processing unit 250 can provide search performance of shared data and data visualization functions by creating meta context through the deep learning analysis engine.

FIG. 3 shows a detailed configuration diagram of the data classification unit in the metadata management system for inter-company data sharing according to the present invention.

As described above, corporate data is classified by the data classification unit 210 according to data attributes. In one embodiment according to the present invention, corporate data may be classified into transaction data, master data, and metadata in a classification system. In this case, the data classification unit 210 includes a classification definition unit 211 that defines the classification for each data and a domain management unit 212 that manages the domain of each data.

The classification definition unit 211 defines data to classify the data according to the attributes of corporate data, and accordingly classifies the data into transaction data, master data, and metadata. The domain management unit 212 manages corporate data for each domain for each data defined in the classification definition unit 211.

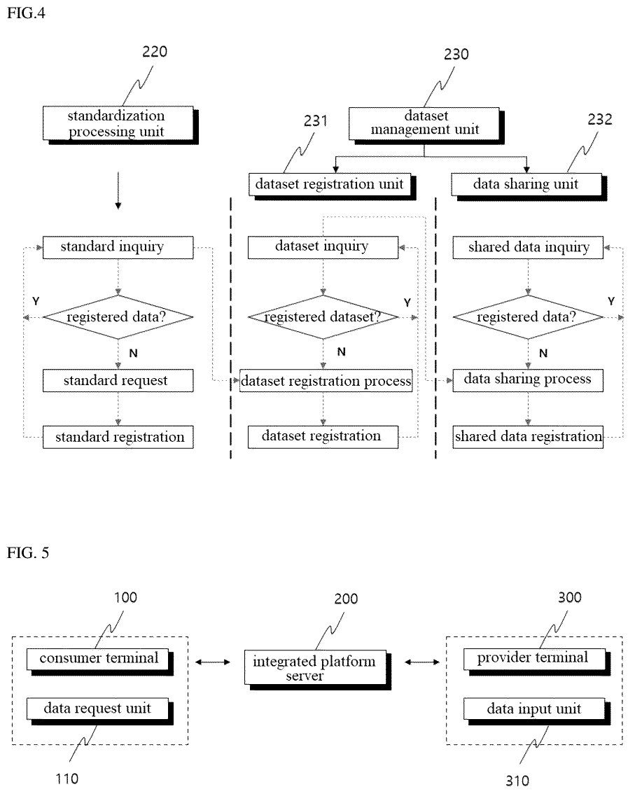

FIG. 4 shows a detailed configuration diagram of the dataset management unit in the metadata management system for inter-company data sharing according to the present invention.

The provider terminal 300, which provides corporate data, checks whether the initially created corporate data has been standardized and then registers the dataset if the standardization registration is completed. After the dataset registration is completed, when the consumer requests to share corporate data, the provider terminal 300 provides the corresponding data. In this case, the dataset management unit 230 configured in the integrated platform server 200 includes a dataset registration unit 231 that registers standardized corporate data as a dataset and a data sharing unit 232 that shares data registered as the dataset when requested by the consumer terminal.

The dataset registration unit 231 registers the corporate data standardized through the standardization processing unit 220 as a dataset. In this case, the dataset registration unit 231 first checks whether the corporate data to be registered is registered as an existing dataset, and shares the registered data with the data sharing unit 232 upon request by the consumer without going through a registration process. However, if data is not registered as an existing dataset, the data is registered and stored in a database through the dataset registration process, and then the next procedure proceeds.

In this case, as an example of the process according to the present invention, the dataset registration process of corporate data may be performed through the consumer terminal 100.

When new corporate data required by the consumer is generated, the consumer terminal 100 requests the new corporate data to the provider terminal 300 through the integrated platform server 200, and when standardization registration and dataset registration for the requested new corporate data are completed in the provider terminal 300, the new corporate data is registered as shared data and then provided to the consumer terminal 100.

This does not mean that when specific corporate data that has not been confirmed as shared data is requested by the consumer, the relevant corporate data is unilaterally provided, but in accordance with the technical gist of the present invention, when any corporate data (unregistered data) is preferentially requested by the consumer terminal 100, the provider terminal 300 performs the standardization process and the dataset process on the corporate data through the integrated platform server 200 and then provides the corresponding corporate data to the consumer terminal 100.

FIG. 5 shows a detailed configuration diagram of the consumer terminal 100 and the provider terminal 300 in the metadata management system for inter-company data sharing according to the present invention.

The provider terminal 300 according to the present invention corresponds to the side that provides corporate data, and the consumer terminal 100 corresponds to the side that receives corporate data.

Accordingly, the provider terminal 300 includes a data input unit 310 to provide various corporate data generated by the company to the integrated platform server 200, and the consumer terminal 100 includes a data request unit 110 to input corporate data to be shared when arbitrary corporate data is needed.

When shared data is requested through the consumer terminal 100, the integrated platform server 200 may provide the requested shared data only to pre-registered authorized users or authorized users who can request it. If there is no authorization, the consumer terminal 100 cannot request to share corporate data.

In the present invention constructed as described above, by standardizing different corporate data for each company and business and managing it as metadata, the efficiency of inter/intra-company data management is increased, so that operational efficiency such as quality improvement and productivity increase can be improved through inter/intra-company data management.

Although the present invention has been described and illustrated with respect to preferred embodiments for illustrating the principles of the present invention, the present invention is not limited to the construction and operation as shown and described. Those skilled in the art will understand that many changes and modifications can be made to the present invention without departing from the idea and scope of the appended claims. Accordingly, all such appropriate changes, modifications and equivalents should be considered to fall within the scope of the present invention.

What is claimed is:

1. A metadata management system for inter-company data sharing, comprising:
a provider terminal for, when corporate data including management data, equipment data, operation data, work data, computer data, and accounting data generated from corporate activities are created, inputting the corporate data to check whether the corporate data is standard data and process standard data registration if not registered, processing shared data registration for sharing the corporate data between companies through dataset registration for the standard data registered;
an integrated platform server including: a data classification unit configured to classify the corporate data into transaction data, master data, and meta data when the standard data registration is processed by the provider terminal: a standardization processing unit configured to standardize the corporate data according to classification by company and business; and a dataset management unit configured to classify and store the corporate data processed in the standardization processing unit as datasets grouped into arbitrary groups, the integrated platform server registering corporate data generated by the provider terminal as shared data through standardization registration and dataset registration and then providing the shared data to a consumer side; and
a consumer terminal for receiving the shared data standardized and processed into a dataset through the integrated platform server to use the shared data as corporate data required for corporate activities,
wherein when new corporate data required by the consumer side is generated, the consumer terminal requests the new corporate data to the provider terminal through the integrated platform server, and the requested new corporate data is registered as shared data upon completion of standardization registration and dataset registration in the provider terminal, and then provided to the consumer terminal.

2. The metadata management system of claim 1, wherein the data classification unit includes:
a classification definition unit that defines corporate data received from the provider terminal as transaction data, master data, and meta data; and
a domain management unit that manages corporate data by domain for each data defined in the classification definition unit.

3. The metadata management system of claim 1, wherein the dataset management unit includes:
a dataset registration unit that registers corporate data that has been standardized in the standardization processing unit as a dataset; and
a data sharing unit that shares data registered as the dataset when requested by the consumer terminal.
